(19) United States
(12) Patent Application Publication
(10) Pub. No.: US 2017/0193533 A1
(43) Pub. Date: Jul. 6, 2017

(54) AUTOMATIC DETECTION OF USER PERSONALITY TRAITS BASED ON SOCIAL MEDIA IMAGE POSTS

(71) Applicant: International Business Machines Corporation, Armonk, NY (US)

(72) Inventors: Jennifer Lai, Southbank (AU); Shaila Pervin, Docklands (AU); Anna Phan, Brighton (AU); Wanita Sherchan, Southbank (AU)

(21) Appl. No.: 14/985,581

(22) Filed: Dec. 31, 2015

(51) Int. Cl. G06Q 30/02; G06F 17/30; G06N 3/08; G06N 3/063; G06K 9/62; G06K 9/32

(52) U.S. Cl. CPC G06Q 30/0202; G06K 9/62; G06K 9/325; G06N 3/08; G06N 3/0635; G06F 17/30864

(57) ABSTRACT

Embodiments are directed to a computer implemented method of analyzing image data. The method includes receiving, using a processor system, image data of one or more images and associated text data that have been posted by a user. The method further includes analyzing the image and text data to extract one or more image and one or more text features, and analyzing the one or more image and one or more text features to predict personality traits, needs and values of the user.

### BACKGROUND

The present disclosure relates in general to the field of image data analytics. More specifically, the present disclosure relates to systems and methodologies for using social media image content to predict personality trait data of a user, which can be used to develop targeted marketing-type and/or advertising-type business strategies based on the identification and grouping of the predicted personality trait data.

The ability to target advertisements, in terms of both content and scope, to specific population segments is a fundamental requirement for effective marketing and advertising campaigns. Marketing and advertising business strategies often involve an analysis of a population's tastes and needs based on information that members of the population share through various electronic media. In e-commerce settings, for example, the analysis employed is often semantic, wherein what a user searches or writes about is used to infer what a user needs. An example of a semantic-based advertising strategy is known generally as semantic targeting. Semantic targeting is a technique enabling the delivery of targeted advertising for advertisements appearing on websites and is used by online publishers and advertisers to increase the effectiveness of their campaigns. The selection of advertisements is served by automated systems based on the content displayed to the user.

With the increasing popularity of sharing images by posting them on social media sites, there is value in being able to understand more about the person posting the image. Image sharing sites such as Instagram currently have millions of users and billions of images. The ability to automatically infer the personality traits of an individual based on images posted by the individual would be beneficial for a number of applications. In addition to the above-described advertising campaign applications, other applications include understanding the characteristics of users who like or dislike a campaign/event/promotion, or detecting changes in an individual's personality traits over time (e.g., detecting when a person is suffering from depression or post traumatic stress syndrome (PTSD)). In the context of the present disclosure, personality traits refer to generally accepted personality traits in psychology, which include but are not limited to the big five personality traits and their facets or sub-dimensions, as well as the personality traits defined by other models such as Kotler's and Ford's Needs Model and Schwartz's Values Model.

Although there is a vast amount of content on social media sharing sites, many users do not provide any data about themselves. Incomplete and non-existent user profiles can limit the usefulness and ability to gain information about the people who are posting the information. Conventional systems typically rely on external metadata associated with images, such as keywords or textual descriptions to predict or estimate information about the person posting (e.g., demographic information such as gender). For example, conventional systems might recommend images tagged as #cat to a person who liked another image tagged as #kitten. Additionally, no attempt is made to classify the personality traits of a person who shared the image.

Accordingly, it would be beneficial to provide an automated approach in which user attributes can be predicted based on the content posted by the user.

### SUMMARY

Embodiments are directed to a computer implemented method of analyzing image data. The method includes receiving, using a processor system, image data of one or more images that have been posted by a user. The method further includes analyzing the image data to extract one or more image features, and analyzing the one or more image features to predict personality traits of the user.

Embodiments are further directed to a computer system for analyzing image data. The system includes a memory and a processor system communicatively coupled to the memory. The processor is configured to perform a method that includes receiving image data of one or more images that have been posted by a user. The method further includes analyzing the image data to extract one or more image features, and analyzing the one or more image features to predict personality traits of the user.

Embodiments are further directed to a computer program product for analyzing image data. The computer program product includes a computer readable storage medium having program instructions embodied therewith, wherein the computer readable storage medium is not a transitory signal per se. The program instructions are readable by a processor system to cause the processor system to perform a method that includes receiving image data of one or more images that have been posted by a user. The method further includes analyzing the image data to extract one or more image features, and analyzing the one or more image features to predict personality traits of the user.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an image data analysis system according to one or more embodiments;

FIG. 2 depicts a flow diagram illustrating a methodology according to one or more embodiments;

FIG. 3 depicts a flow diagram illustrating another methodology according to one or more embodiments;

FIG. 4 depicts a diagram illustrating an e-commerce system incorporating an image data analysis system according to one or more embodiments;

FIG. 5 depicts a computer system capable of implementing hardware components of one or more embodiments; and

FIG. 6 depicts a diagram of a computer program product according to one or more embodiments.

In the accompanying figures and following detailed description of the disclosed embodiments, the various elements illustrated in the figures are provided with three digit reference numbers. The leftmost digits of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. Various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

Additionally, although this disclosure includes a detailed description of a computing device configuration including a feature extractor and a machine learning module, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

Further, although this disclosure includes a detailed description of analyzing image data in order to derive parameters of a marketing-type or advertising-type e-commerce business strategy/campaign development system, implementation of the teachings recited herein are not limited to marketing-type or advertising-type business strategy/campaign development systems. Rather, embodiments of the present disclosure are capable of being implemented in conjunction with any other type of business strategy/campaign development system, now known or later developed, wherein the strategy/campaign is focused and targeted based at least in part on the identification and grouping of communication targets using the identification, analysis and grouping of predicted personality traits from among a population.

Turning now to an overview of the present disclosure, one or more embodiments provide systems and methodologies that automatically identify a selected user's personality traits based on the user's social media posts, which may include images only or images and associated textual content. In contrast to existing personality prediction systems that analyze images of a user in order to derive data on the facial features the user, the systems and methodologies of the present disclosure automatically identify a selected user's personality traits based at least in part on the overall features of images and/or textual content that the user posts on social media. The features analyzed according to the present disclosure are not focused on facial features of the user contained in the posted image, but are instead focused on features of the overall image such as lighting, specific image contents, colors, angles, applied image filters and the like. With the prevalence of social media usage in the population, and with the increasing volume of content shared in various social media platforms, the present disclosure provides an efficient method for predicting and gathering personality traits of the users at scale.

The predicted personality traits can be used as inputs to a variety of systems that utilize market intelligence to identify and target certain portions of the population for products, services or endeavors such as membership/participation in an organization. For example, the predicted personality traits developed according to the present disclosure allow grouping of users into affiliations networks based on predicted personality traits. These predicted personality traits and their groupings into affiliations may be utilized by other downstream components (e.g., targeted business strategy systems) to develop and deliver targeted business strategies based at least in part on an identified nexus between desired business outcomes and individuals and/or ad hoc population groups (e.g., ad hoc affiliation networks) having one or more of the predicted personality traits in common. Desired business outcomes may include a variety of outcomes, including but not limited to purchasing a product/service, joining a group, volunteering time to a political campaign, voting for a particular candidate/referendum, writing letters of support, donating to a charity and the like. Advantageously, members of the ad hoc affiliation networks developed according to the present disclosure may or may not know each other or have ever communicated with each other. The commonality among members of the disclosed ad hoc affiliation networks is based on the system of the present disclosure determining that the members of the ad hoc affiliation network have one or more identified predicted personality traits in common.

At least the features and combinations of features described in the immediately preceding paragraphs, including the corresponding features and combinations of features depicted in the figures amount to significantly more than implementing a method of developing a business campaign in a particular technological environment. Additionally, at least the features and combinations of features described in the immediately preceding paragraphs, including the corresponding features and combinations of features depicted in the figures go beyond what is well-understood, routine and conventional in the relevant field(s).

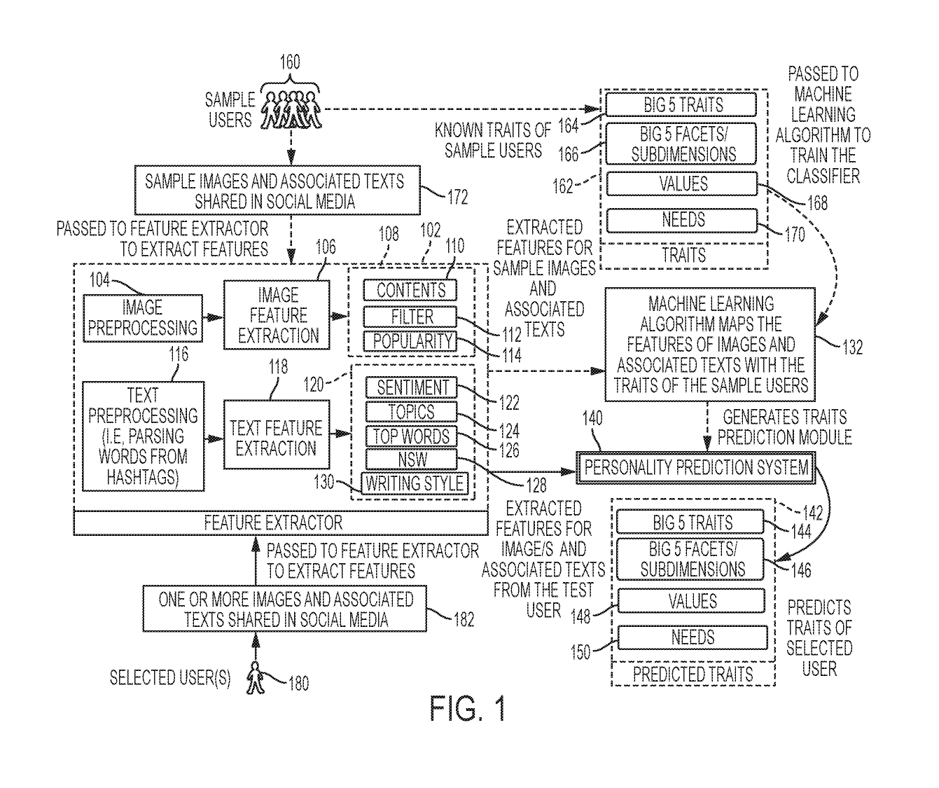

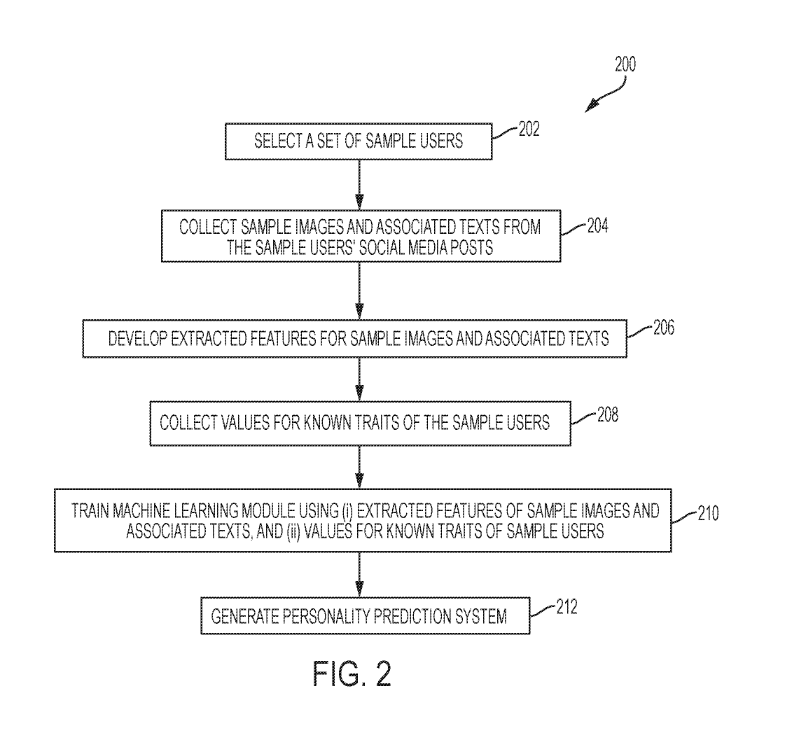

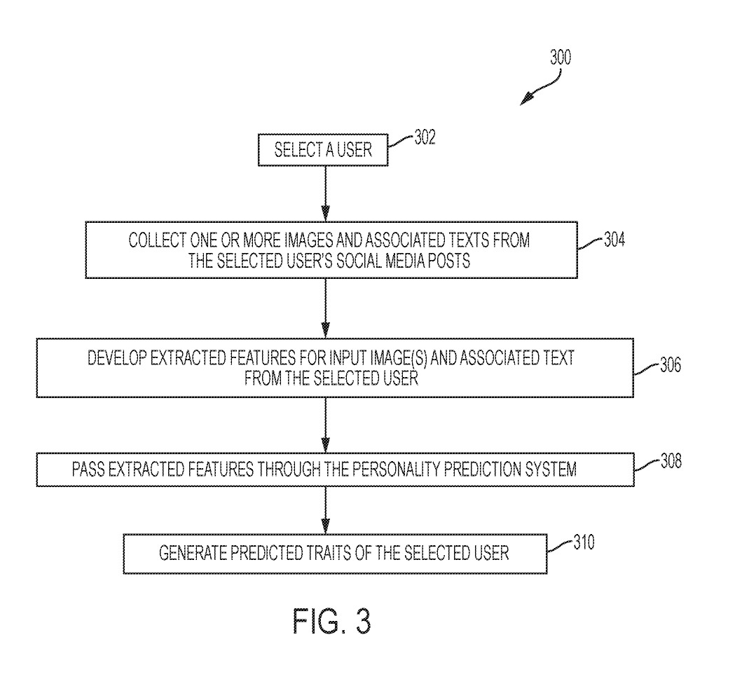

Turning now to a more detailed description of the present disclosure, FIG. 1 depicts an exemplary image data analysis system 100 capable of implementing one or more embodiments. FIGS. 2 and 3 depict methodologies 200, 300 performed by image data analysis system 100. The following description of the components and operation of image data analysis system 100 makes reference to components of image data analysis system 100 shown in FIG. 1, methodology 200 shown in FIG. 2 and methodology 300 shown in FIG. 3.

Image data analysis system 100 includes a feature extractor 102, a machine learning module 132 and a personality prediction system 140, configured and arranged as shown. Feature extractor 102 includes an image preprocessing module 104 and an image feature extraction module 106, configured and arranged as shown to generate a first set of extracted feature data 108. Feature extractor 102 further includes a textual content preprocessing module 116 and a textual content feature extraction module 118, configured and arranged as shown to generate a second set of extracted feature data 120.

Image data analysis system 100 further includes a first data input module 172 and a second data input module 182, configured and arranged as shown. First data input module 172 provides as inputs to feature extractor 102 sample images and associated textual content shared through social media sites by a set of sample users 160. First data input module 172 provides inputs to feature extractor 102 as a part of implementing methodology 200, which is a training methodology for training machine learning module 132 to generate personality prediction system 140. Second data input module 182 provides as inputs to feature extractor 102 one or more images and associated textual content shared through social media sites by a selected user 180. Second data input module 182 provides inputs to feature extractor 102 as a part of implementing methodology 300, which is a methodology for using machine learning module 132 and personality prediction system 140 to generate predicted personality traits 142 of selected user 180.

First and second data input modules 172, 182 may be implemented using any system that is capable of receiving and/or gathering image and/or associated textual content data from internet web sites. For example, modules 172, 182 may include a web crawler (not shown) that includes functionality to allow it to mine and gather communications (e.g., customer reviews at web sites, instant messages, tweets, multimedia chats, Facebook content, etc.) from internet web sites. A web crawler is a program that visits web sites and reads their pages and other information in order to create entries for a search engine index. The major search engines on the web all have such a program, which is also known as a “spider” or a “bot.” Web crawlers are typically programmed to visit sites that have been submitted by their owners as new or updated. Entire sites or specific pages can be selectively visited and indexed. Web crawlers crawl through a site a page at a time, following the links to other pages on the site until all pages have been read.

Sample users 160 and selected user 180 may be a person or persons who interface with the internet for posting images and/or associated textual content. Posting images and/or associated textual content typically occur through social media activities but can occur through any internet interaction through which sample users 160 or user 180 can post images and/or associated textual content. As used in the present disclosure, the term posting includes any activity that makes an image and/or associated textual content available over the internet. The internet availability may be unlimited or restricted as long as there is an ability for others to access the image and/or associated textual content.

Sample users 160 are identified and used for training based on sample users 160 having a predefined relationship with the desired types of selected user 180. In general, it is expected that selected user 180 will have similar traits (e.g., traits 162) as one or more members of sample users 160. For example, if it is expected that selected user 180 will come from a pool of high school varsity football players in the state of Texas, sample users 160 will be drawn from the pool of high school varsity football players in the state of Texas. The actual number of sample users 160 is selected based on a variety of factors, including the quality and scope of available image and/or associated textual content data, the cost of assembling image and/or associated textual content data, and the desired accuracy of the training.

Machine learning module 132 includes a trainable machine learning algorithm that maps features of images and/or associated textual content with traits 162 of sample users 160. In one or more embodiments, machine learning module 132 includes an ensemble of machine learning algorithms. In one or more embodiments, machine learning module 132 includes an artificial neural network (ANN) not shown having the capability to be trained to perform a particular function. Machine learning broadly describes a primary function of electronic systems that learn from data. In machine learning and cognitive science, ANNs are a family of statistical learning models inspired by the biological neural networks of animals, and in particular the brain. ANNs may be used to estimate or approximate systems and functions that depend on a large number of inputs and are generally unknown.

ANNs are often embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons which may be activated by the pixels of an input image. After being weighted and transformed by a function determined by the network's designer, the activations of these input neurons are then passed to other downstream neurons, which are often referred to as “hidden” neurons. This process is repeated until an output neuron is activated. The activated output neuron determines which character was read.

Referring now to FIGS. 1, 2 and 3, according to one or more embodiments, image data analysis system 100 operates according to two stages, namely a training stage illustrated by methodology 200 and a usage stage illustrated by methodology 300. The training stage begins by selecting sample users 160 (block 202). First data input module 172 collects sample images and/or associated textual content from the social media posts of sample users 160 (block 204). First data input module 172 passes image data, which may include data of images and associated textual content, to image preprocessing module 104 and textual content preprocessing module 116 of feature extractor 102. Image preprocessing module 104 and image feature extraction module 106 process the data of images and generate first set of extracted feature data 108, which includes both low-level and high-level image features such as image contents 110 (e.g., objects depicted in the image), filter(s) used 112 (e.g., black and white, highlights) and popularity 14 (e.g., number of likes, comments and shares). Textual content preprocessing module 116 and textual content feature extraction module 118 process the data of the associated textual content and generate second set of extracted feature data 120, which includes textual features such as sentiment 122, topics 124, top words 126, non-standard words (NSW) 128 (e.g., “u” instead of “you” and non-word symbols such as #, !, etc.) and writing style 130. Accordingly, feature extractor 102 develops extracted features for sample images and associated textual content (block 206).

Values for known traits 162 of sample users 160 are collected using known data gathering techniques (block 208). Known traits 162 include but are not limited to broader personality traits such as the big five 164, their facets/sub-dimensions 166, the user's inferred needs 168 and inferred values 170. The extracted features for sample images and associated textual content generated by feature extractor 102, along with known traits 162 are provided to machine learning module 132 for training machine learning module 132 (block 210). Machine learning module 132 includes a machine learning algorithm that maps the features of images and associated textual content with known traits 162 of sample users 160 and generates traits prediction system 140 (block 212).

The usage stage begins by selecting user 180 (block 302). Second data input module 182 collects images and/or associated textual content from the social media posts of user 180 (block 304). Second data input module 182 passes image data, which may include data of images and associated textual content, to image preprocessing module 104 and textual content preprocessing module 116 of feature extractor 102. Image preprocessing module 104 and image feature extraction module 106 process the data of images and generate first set of extracted feature data 108, which includes both low-level and high-level image features such as image contents 110 (e.g., objects depicted in the image), filter(s) used 112 (e.g., black and white, highlights) and popularity 14 (e.g., number of likes, comments and shares). Textual content preprocessing module 116 and textual content feature extraction module 118 process the data of the associated textual content and generate second set of extracted feature data 120, which includes textual features such as sentiment 122, topics 124, top words 126, non-standard words (NSW) 128 (e.g., “u” instead of “you” and non-word symbols such as #, !, etc.) and writing style 130. Accordingly, feature extractor 102 develops extracted features for input images and associated textual content (block 306). The extracted features for sample images and associated textual content generated by feature extractor 102 is provided to personality prediction system 140 (block 308), which generates predicted personality traits 142 of user 180 (block 310) including but not limited to broader personality traits such as the big five 144, their facets/sub-dimensions 146, the user's inferred needs 148 and inferred values 150

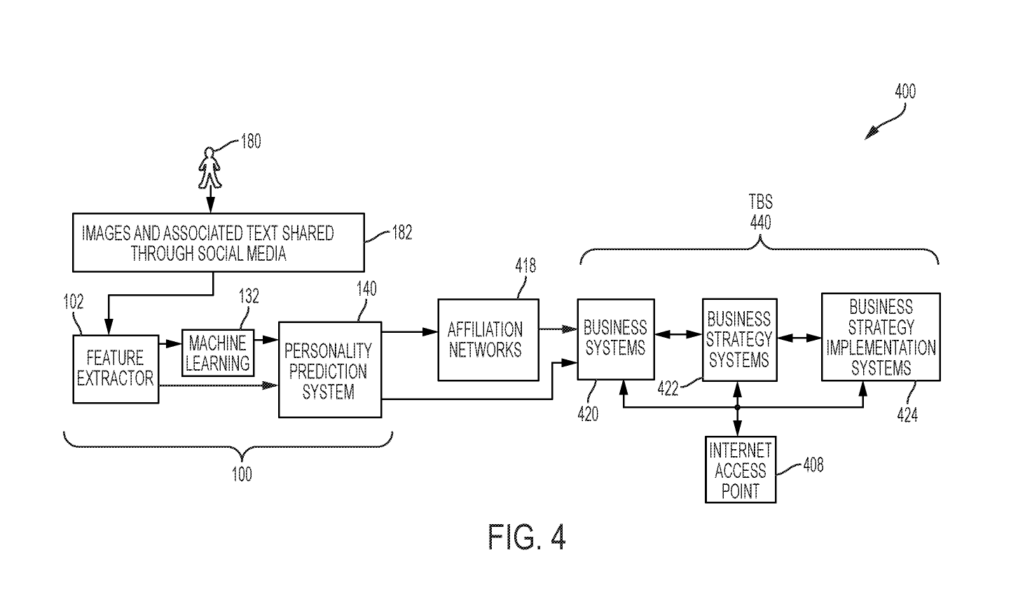

Predicted personality traits 142 generated by personality prediction system 140 of image data analysis system 100 can be used as inputs to a variety of systems that utilize market intelligence to identify and target certain portions of the population for products, services or endeavors such as membership/participation in an organization. As an example, FIG. 4 depicts a diagram illustrating an e-commerce-based targeted business strategy development and implementation system (e-commerce system) 400 that incorporates image data analysis system 100 according to one or more embodiments. E-commerce system 400 includes second data input module 182, feature extractor 102, machine learning module 132, personality prediction system 140, an affiliation networks module 418, a business systems module 420, a business strategy systems module 422 and a business strategy implementation systems module 424, configured and arranged as shown.

The term e-commerce refers to trading in products or services using computer networks, such as the internet. E-commerce draws on technologies such as mobile commerce, electronic funds transfer, supply chain management, internet marketing, online transaction processing, electronic data interchange (EDI), inventory management systems, and automated data collection systems. Modern e-commerce typically uses the internet for at least one part of the transaction's life cycle, although it may also use other technologies such as e-mail. E-commerce businesses employ a variety of system functionalities, including but not limited to online shopping web sites for retail sales direct to consumers, providing or participating in online marketplaces that process third-party business-to-consumer or consumer-to-consumer sales, business-to-business buying and selling; gathering and using demographic data through web contacts and social media, business-to-business electronic data interchange, marketing to prospective and established customers by e-mail or fax (for example, with newsletters), and engaging in retail for launching new products and services. However, the term e-commerce as used in the present disclosure is not limited to for-profit activities, and is intended to include activities such as philanthropic, political, social, volunteer and the like.

Predicted personality traits 142 (shown in FIG. 1) generated by personality prediction system 140 of image data analysis system 100 can be used as inputs to affiliations network module 418, which develop secondary, ad hoc networks of individuals, referred to herein as affiliation networks. The affiliation networks developed by affiliations network module 418 are based on predicted personality traits 142 and does not require that individuals in the affiliations network know each other or have interacted in the past. Business systems module 420 utilize both affiliations network data from affiliations networks module 418 and predicted personality traits 142 as inputs to a variety of business processes and/or functions including but not limited marketing systems, merchandising systems, supply chain systems, and others. Business strategy systems module 422 develop business strategies that are targeted based at least in part on an identified nexus between desired business outcomes (e.g., purchasing a product or a service) and individuals and/or groups having one or more of predicted personality traits 142 in common. Business strategy implementation systems module 424 develops systems to implement business strategies that are targeted based at least in part on an identified nexus between desired business outcomes (e.g., purchasing a product or a service) and individuals and/or groups having one or more of predicted personality traits 142.

Business systems module 420, business strategy systems module 422 and business strategy implementation systems module 424 all have access to the internet through internet access point 408. Thus, the ability of e-commerce system 400 through image data analysis system 100 to identify individuals and/or groups having one or more predicted personality traits 142 in common enables business systems module 420, business strategy systems module 422 and business strategy implementation systems module 424 to identify a nexus between desired business outcomes and individuals and/or groups having one or more predicted personality traits 142 in common, and further enables these business systems to plan and execute dynamic business strategies that anticipate, exploit and closely link to predicted personality traits 142 and the identified nexus.

The overall functionality provided by business systems 420, business strategy systems 422 and business strategy implementation systems 424 are identified collectively as a targeted business strategy development system (TBS) 440, which may take a wide variety of formats, and which may or may not include each function of business systems 420, business strategy systems 422 and business strategy implementation systems 424. TBS 440 (e.g., a marketer or a seller) may implement its developed marketing or advertising campaign through voice, email, fax, chat messages associated with an avatar, instant messages, etc.

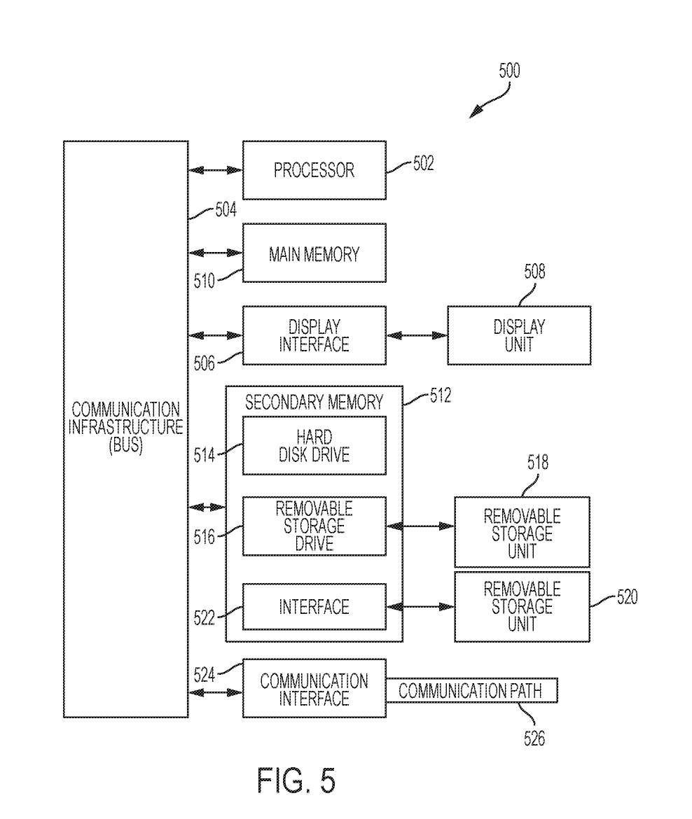

FIG. 5 depicts a high level block diagram computer system 500, which may be used to implement one or more embodiments of the present disclosure. More specifically, computer system 500 may be used to implement hardware components of image analysis system 100 shown in FIG. 1 and e-commerce system 400 shown in FIG. 4. Although one exemplary computer system 500 is shown, computer system 500 includes a communication path 526, which connects computer system 500 to additional systems (not depicted) and may include one or more wide area networks (WANs) and/or local area networks (LANs) such as the Internet, intranet(s), and/or wireless communication network(s). Computer system 500 and additional system are in communication via communication path 526, e.g., to communicate data between them.

Computer system 500 includes one or more processors, such as processor 502. Processor 502 is connected to a communication infrastructure 504 (e.g., a communications bus, cross-over bar, or network). Computer system 500 can include a display interface 506 that forwards graphics, textual content, and other data from communication infrastructure 504 (or from a frame buffer not shown) for display on a display unit 508. Computer system 500 also includes a main memory 510, preferably random access memory (RAM), and may also include a secondary memory 512. Secondary memory 512 may include, for example, a hard disk drive 514 and/or a removable storage drive 516, representing, for example, a floppy disk drive, a magnetic tape drive, or an optical disk drive. Removable storage drive 516 reads from and/or writes to a removable storage unit 518 in a manner well known to those having ordinary skill in the art. Removable storage unit 518 represents, for example, a floppy disk, a compact disc, a magnetic tape, or an optical disk, etc. which is read by and written to by removable storage drive 516. As will be appreciated, removable storage unit 518 includes a computer readable medium having stored therein computer software and/or data.

In alternative embodiments, secondary memory 512 may include other similar means for allowing computer programs or other instructions to be loaded into the computer system. Such means may include, for example, a removable storage unit 520 and an interface 522. Examples of such means may include a program package and package interface (such as that found in video game devices), a removable memory chip (such as an EPROM, or PROM) and associated socket, and other removable storage units 520 and interfaces 522 which allow software and data to be transferred from the removable storage unit 520 to computer system 500.

Computer system 500 may also include a communications interface 524. Communications interface 524 allows software and data to be transferred between the computer system and external devices. Examples of communications interface 524 may include a modem, a network interface (such as an Ethernet card), a communications port, or a PCM-CIA slot and card, etcetera. Software and data transferred via communications interface 524 are in the form of signals which may be, for example, electronic, electromagnetic, optical, or other signals capable of being received by communications interface 524. These signals are provided to communications interface 524 via communication path (i.e., channel) 526. Communication path 526 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 510 and secondary memory 512, removable storage drive 516, and a hard disk installed in hard disk drive 514. Computer programs (also called computer control logic) are stored in main memory 510 and/or secondary memory 512. Computer programs may also be received via communications interface 524. Such computer programs, when run, enable the computer system to perform the features of the present disclosure as discussed herein. In particular, the computer programs, when run, enable processor 502 to perform the features of the computer system. Accordingly, such computer programs represent controllers of the computer system.

Thus it can be seen from the forgoing detailed description that one or more embodiments of the present disclosure provide technical benefits and advantages. Systems and methodologies of the present disclosure automatically predict a selected user's personality traits, needs and values based on the user's social media posts, which may include images only or images and associated textual content. In contrast to existing personality prediction systems that analyze images of a user in order to derive data on the facial features the user, the systems and methodologies of the present disclosure automatically identify a selected user's personality traits based at least in part on the overall features of images and/or textual content that the user posts on social media. The features analyzed according to the present disclosure are not focused on facial features of the user contained in the posted image, but are instead focused on features of the overall image such as lighting, specific image contents, colors, angles, and the like. With the prevalence of social media usage in the population, and with the increasing volume of content shared in various social media platforms, the present disclosure provides an efficient method for predicting and gathering personality traits of the users at scale.

The predicted personality traits can be used as inputs to a variety of systems that utilize market intelligence to identify and target certain portions of the population for products, services or endeavors such as membership/participation in an organization. For example, the predicted personality traits developed according to the present disclosure allow grouping of users into affiliations networks based on predicted personality traits. Targeted marketing plans and targeted advertising are deployed to related users based on the identified affiliations network. Advantageously, members of the ad hoc affiliation networks developed according to the present disclosure may or may not know each other or have ever communicated with each other. The commonality among members of the disclosed ad hoc affiliation networks is based on the system of the present disclosure determining that the members of the ad hoc affiliation network have one or more identified predicted personality traits in common.

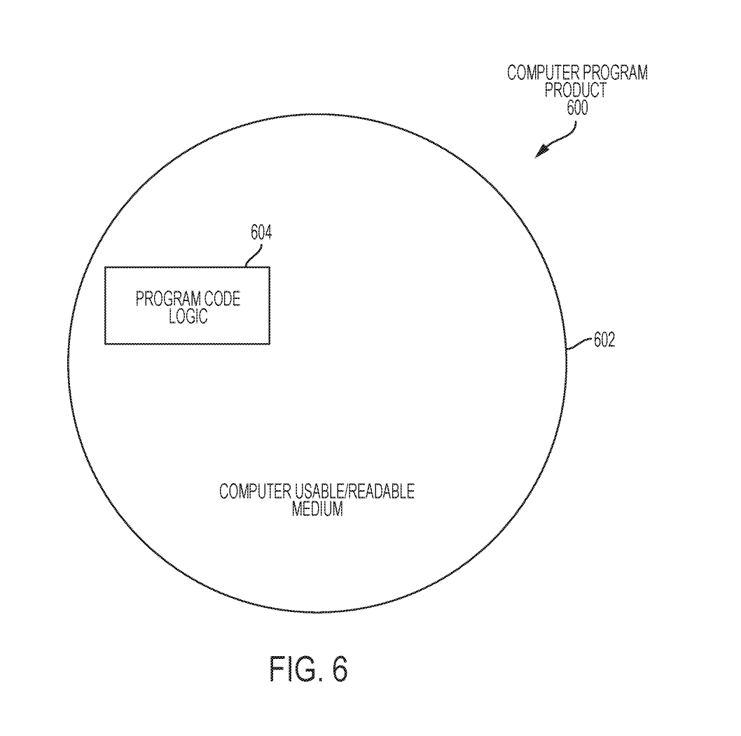

Referring now to FIG. 6, a computer program product 600 in accordance with an embodiment that includes a computer readable storage medium 602 and program instructions 604 is generally shown.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer implemented method of analyzing image data, the method comprising:
receiving, using a processor system, image data of one or more images that have been posted by a user;
analyzing, using the processor system, the image data to extract one or more image features; and
analyzing, using the processor system, the one or more image features to predict personality traits of the user.

2. The computer implemented method of claim 1, wherein:
the processor system includes a machine learning module; and
the analyzing of the one or more image features to predict the personality traits of the user is performed using the machine learning module.

3. The computer implemented method of claim 2, wherein:
the machine learning module includes a trainable machine learning algorithm; and
the method further comprises training the trainable machine learning algorithm.

4. The computer implemented method of claim 1 further comprising:
analyzing, using the processor system, the image data to extract one or more textual features of textual content associated with the one or more images; and
analyzing, using the processor system, the one or more textual features to further predict the personality traits of the user.

5. The computer implemented method of claim 4, wherein:
the processor system includes a machine learning module;
the analyzing of the one or more image features to predict the personality traits of the user is performed using the machine learning module; and
the analyzing of the one or more textual features to further predict the personality traits of the user is performed using the machine learning module.

6. The computer implemented method of claim 5, wherein:
the machine learning module includes a trainable machine learning algorithm; and
the method further comprises training the trainable machine learning algorithm.

7. The computer implemented method of claim 1 further comprising:
analyzing, using the processor system, the one or more image features to predict needs or values of the user; and
deriving a targeted business strategy based at least in part on the personality traits, needs or values of the user.

8. A computer system for analyzing image data, the system comprising:
a memory; and
a processor system communicatively coupled to the memory;
the processor system configured to perform a method comprising:
receiving image data of one or more images that have been posted by a user;
analyzing the image data to extract one or more image features; and
analyzing the one or more image features to predict personality traits of the user.

9. The computer system of claim 8, wherein:
the processor system includes a machine learning module; and
the analyzing of the one or more image features to predict the personality traits of the user is performed using the machine learning module.

10. The computer system of claim 9, wherein:
the machine learning module includes a trainable machine learning algorithm; and
the method further comprises training the trainable machine learning algorithm.

11. The computer system of claim 8 further comprising:
analyzing, using the processor system, the image data to extract one or more textual features of textual content associated with the one or more images; and
analyzing, using the processor system, the one or more textual features to further predict the personality traits of the user.

12. The computer system of claim 11, wherein:
the processor system includes a machine learning module;
the analyzing of the one or more image features to predict the personality traits of the user is performed using the machine learning module; and
the analyzing of the one or more textual features to further predict the personality traits of the user is performed using the machine learning module.

13. The computer system of claim 12, wherein:
the machine learning module includes a trainable machine learning algorithm; and
the method further comprises training the trainable machine learning algorithm.

14. The computer system of claim 8 further comprising:
analyzing the one or more images features to predict values or needs of the user; and
deriving a targeted business strategy based at least in part on the personality traits, values or needs of the user.

15. A computer program product for analyzing image data, the computer program product comprising:
a computer readable storage medium having program instructions embodied therewith, wherein the computer readable storage medium is not a transitory signal per se, the program instructions readable by a processor system to cause the processor system to perform a method comprising:
receiving image data of one or more images that have been posted by a user;
analyzing the image data to extract one or more image features; and
analyzing the one or more image features to predict personality traits of the user.

16. The computer program product of claim 15, wherein:
the processor system includes a machine learning module; and
the analyzing of the one or more image features to predict the personality traits of the user is performed using the machine learning module.

17. The computer program product of claim 16, wherein:
the machine learning module includes a trainable machine learning algorithm; and
the method further comprises training the trainable machine learning algorithm.

18. The computer program product of claim 15 further comprising:
analyzing, using the processor system, the image data to extract one or more textual features of textual content associated with the one or more images; and
analyzing, using the processor system, the one or more textual features to further predict the personality traits of the user.

19. The computer program product of claim 18, wherein:
the processor system includes a machine learning module;
the analyzing of the one or more image features to predict the personality traits of the user is performed using the machine learning module;
the analyzing of the one or more textual features to further predict the personality traits of the user is performed using the machine learning module.
the machine learning module includes a trainable machine learning algorithm; and
the method further comprises training the trainable machine learning algorithm.

20. The computer program product of claim 15 further comprising:
analyzing the one or more features to predict values or needs of the user; and
controlling a business strategy development system to derive a targeted business strategy based at least in part on the personality traits, needs or values of the user.
